(19) United States
(12) Patent Application Publication
(10) Pub. No.: US 2009/0197072 A1
(43) Pub. Date: Aug. 6, 2009

(54) PROCESS FOR PRODUCING A HEAT-COMPRESSED MELAMINE FOAM CLEANING IMPLEMENT

(76) Inventors: Denis Alfred Gonzales, Brussels (BE); Iris Bogaerts, Mechelen (BE); Stephen Lee Childs, Cincinnati, OH (US); Jan Paul Maria Vanlierde, Meise (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/396,415

(22) Filed: Mar. 2, 2009

Related U.S. Application Data
(63) Continuation of application No. 11/521,962, filed on Sep. 15, 2006, now abandoned.
(60) Provisional application No. 60/718,092, filed on Sep. 16, 2005.

(51) Int. Cl. B32B 5/22; B29B 15/00; C09J 5/02

(52) U.S. Cl. 428/316.6; 264/345; 156/322

(57) ABSTRACT

The present invention relates to a process for producing a cleaning implement suitable for hard surface cleaning comprising heat-compressing a melamine foam at about 250° C. to about 300° C., for about 1 minute to below about 3 minutes.

### CROSS REFERENCE TO RELATED APPLICATION

This application claims the benefit of U.S. application Ser. No. 11/521,962, filed Sep. 15, 2006, which claims the benefit of U.S. Provisional Application No. 60/718,092, filed Sep. 16, 2005.

### TECHNICAL FIELD

The present invention relates to a cleaning implement comprising heat-compressed melamine foam. More specifically, the present invention is directed to a cleaning implement wherein the melamine foam has been thermally-compressed at a selected range of temperatures and upon selected duration.

### BACKGROUND OF THE INVENTION

Melamine-formaldehyde resin foams, also referred to herein as melamine foams, are well known in the art for use in industrial applications, for example, as heat or sound insulating materials as well as for fire protection purposes. Indeed, in the automotive industry, melamine foam is commonly used to insulate motor compartments and driver cabins of cars and trucks.

Recently, a novel application for such melamine foams in the area of hard surface cleaning has been discovered. Indeed, cleaning implements of cut or molded pieces of melamine foam have become popular to remove soils and/or stains from hard surfaces (i.e., cleaning of hard surfaces) such as tiles, walls, floors, sanitary fittings such as sinks, showers, shower curtains, wash basins, WCs, household appliances including, but not limited to, refrigerators, freezers, washing machines, automatic dryers, ovens, microwave ovens, dishwashers and so on. Indeed, melamine foam sponges are currently marketed under the tradename Mr. Clean Magic Eraser®. In order to stabilize the melamine foam and to prevent early break-up of it, sponges combining melamine foam and a stabilizing material, such as a rigid polyurethane have been proposed and marketed (sold under the tradename Scotch Brite Easy Erasing Pad® by 3M Corp.). Melamine foam pieces combined with or laminated to a second material are known in the art, for example, from US 2001/0024720 or JP 2001-258809, all incorporated herein by reference.

It is has been observed that melamine foam shows an excellent soil and/or stain removal performance when used to clean hard surfaces. However, despite the apparent suitability of those pieces of melamine foam, it has been found that cleaning performance is occasionally not sufficient to meet consumer expectations, in particular when it relates to remove tough soils such as dried food stains or greasy soap scum, which may typically be found in kitchens and bathrooms.

It is therefore an objective of the present invention to provide a cleaning implement suitable for hard surface cleaning comprising melamine foam, wherein said implement is capable of providing improved cleaning performance benefit on tough soils such as e.g. dried food stains, greasy stains, particulate stains, greasy soap scum, marker or crayon stains, while remaining safe to the treated surface, especially to more delicate hard-surfaces such as Plexiglas, enamel, glazed and non-glazed ceramic tiles, porcelain, linoleum, plastic, plastified wood or metal, varnished parquet, painted surfaces, wall paper, etc.

It has now been found that the above objective can be met by a cleaning implement 1 suitable for hard surface cleaning comprising heat-compressed melamine foam, wherein said heat-compressed melamine foam has been heat-compressed at a temperature of from about 250° C. to about 300° C., for about 1 minute to below about 3 minutes.

Advantageously, by heat-compressing the melamine foam as above-indicated, the cleaning implement 1 according to the present invention exhibits improved mechanical performances and therefore improved durability when compared to non-thermally compressed melamine foams currently available on the market. A further advantage associated with cleaning implements 1 of the present invention is that their mechanical performances are preserved after ageing.

Thermo-compressed melamine foam is already know in the art but almost exclusively, as heat or sound insulating materials in the automotive and building industry. For example, EP-A-0 451 535 and EP-A-0 111 860, all incorporated herein by reference, disclose thermo-compressed melamine foam used for insulation purposes. U.S. Pat. No. 6,608,118 B2, in contrast, describes compressed melamine foam for use in cleaning applications. However, in the latter patent, the foam is thermo-compressed at 210 to 350° C. for 3 minutes or longer.

It is well known that when heat-compression of the melamine foam is performed at a temperature which is too low and/or during a too short period, excessive elastic decompression might occur. Accordingly, another advantage of the cleaning implements herein is that they show no or little reversal of the thermal compression upon storage, even under stressed storing conditions. When compared to the heat-compression process described in U.S. Pat. No. 6,608,118 B2, herein incorporated by reference, the present invention allows achieving performing cleaning implements having similar decompression properties but with reduced compression time. This improvement will translate directly into substantial cost reduction when industrial large scale production is envisaged.

Moreover, it is well recognized that heat-compressing melamine foam at relatively high temperatures, e.g. about 250 to about 350° C., may lead the melamine foam suffering from yellowing, discoloration, decomposition or burning. It is accordingly a further advantage that the melamine foam, when heat-compressed according to the present invention, is not subject to yellowing, discoloration, decomposition or burning.

### SUMMARY OF THE INVENTION

The present invention relates to a cleaning implement 1 suitable for hard surface cleaning comprising heat-compressed melamine foam, wherein said heat-compressed melamine foam has been heat-compressed at about 250° C. to about 300° C., for about 1 minute to below about 3 minutes.

In another embodiment, the present invention is directed to a method of obtaining quasi-permanent compression of melamine foam comprising the step of heat-compressing the melamine foam as indicated above.

The present invention further encompasses the use of a cleaning implement 1 comprising heat-compressed melamine foam for cleaning hard surfaces, wherein the heat-compressed melamine foam has been heat-compressed at about 250° C. to about 300° C., for about 1 minute to below about 3 minutes.

### BRIEF DESCRIPTION OF THE DRAWINGS

FIG. 1 is a perspective view of a cleaning implement 1 according to the present invention. The cleaning implement 1 comprises a repetitive embossed pattern 2 onto the top side of the cleaning implement 1, and two parallel waved sides 3.

FIG. 2 is a top view thereof.

FIG. 3 is a bottom view thereof.

FIG. 4 is a front view thereof (the opposite back view being the same).

FIG. 5 is a side view thereof (the opposite side view being the same).

### DETAILED DESCRIPTION OF THE INVENTION

### Cleaning Implement

The cleaning implement 1 herein comprises melamine foam. By a “cleaning implement” it is meant herein an article of manufacture of any suitable shape and/or size and/or volume suitable for cleaning, i.e., removing spots and/or stains from, hard surfaces. In a highly preferred embodiment according to the present invention, the cleaning implement 1 herein is in a shape and/or size and/or volume suitable for use by a consumer to clean hard surfaces therewith. However, the cleaning implement 1 may also have an irregular shape.

Suitable shapes of the cleaning implement 1 herein may be selected from the group consisting of: cube shape, rectangular shape, pyramid shape, cylindrical shape, cone shape, pencil eraser shape, cuboid shape, tetrahedron shape; sphere shape; globular shape; and ellipsoid shape. Preferably, said cleaning implement 1 has a shape selected from the group consisting of: cube shape, rectangular shape, pencil eraser shape, and cuboid shape.

Suitable volume of the cleaning implement 1 herein may be from about 1 cm³ to about 10.000 cm³, preferably from about 10 cm³ to about 1.000 cm³, more preferably from about 150 cm³ to about 250 cm³.

In a highly preferred embodiment herein, the cleaning implement 1 herein has a cuboid shape defined by three groups of parallel and equal length sides, referred to as a, b and c, wherein a ranges from about 2 cm to about 20 cm, preferably about 4 cm to about 8 cm, b ranges from about 2 cm to about 20 cm preferably about 8 cm to about 15 cm, and c ranges from about 1.5 cm to about 5 cm, preferably about 2 cm to about 4 cm.

In another highly preferred embodiment herein, the cleaning implement 1 herein is in the shape of a pencil eraser. By “shape of a pencil eraser” it is meant herein a voluminous body having six walls, wherein three pairs of parallel and equally shaped and sized walls exist and wherein one pair of walls are in the shape of a parallelogram and the remaining two pairs of walls are of rectangular shape.

The thickness of the cleaning implement 1 herein after heat-compression is at least about 1 mm, preferably from about 5 mm to about 100 mm, more preferably from about 10 mm to about 50 mm, even more preferably from about 15 mm to about 40 mm, and most preferably from about 18 mm to about 25 mm.

By “thickness” it is meant herein, the length in mm of the side having the smallest extension compared to other sides of the melamine foam (the height of the melamine foam). In case the cleaning implement 1 is based on a rectangular shape and the melamine foam extends in parallel to the sides of the shape having the largest surface area (extensions in the x and y axis), the thickness can be referred to as the extension in the direction of the y axis. In case the cleaning implement 1 is based on an irregular shape and/or the extension of the thickness of the melamine foam varies (i.e., the layer is thicker in some parts of the implement 1 as compared to others), it is sufficient that at least once the thickness of the melamine foam extends over the thickness required herein.

### Melamine Foam

By “melamine foam” it is meant herein a melamine-formaldehyde resin foam.

A suitable melamine-formaldehyde resin foam raw material is commercially available under the trade name Basotect® from BASF.

The “melamine foam” described above can be prepared by blending major starting materials of melamine and formaldehyde, or a precursor thereof, with a blowing agent, a catalyst and an emulsifier, injecting the resultant mixture into a mold, and making the reaction mixture generate heat through a proper means such as heating or irradiation with electromagnetic wave to cause foaming and curing. The molar ratio of melamine to formaldehyde (i.e., melamine:formaldehyde) for producing the precursor is preferably about 1:1.5 to about 1:4, particularly preferably about 1:2 to about 1:3.5 in melamine:formaldehyde. In addition, number average molecular weight of the precursor is preferably about 200 to about 1,000, particularly preferably about 200 to about 400. Additionally, formalin, which is an aqueous solution of formaldehyde, is usually used as formaldehyde.

As monomers for producing the precursor, the following various monomers may be used in an amount of about 50 parts by weight (hereinafter abbreviated as “parts”) or less, particularly about 20 parts by weight or less, per about 100 parts by weight of the sum of melamine and formaldehyde in addition to melamine and formaldehyde. As other monomers corresponding to melamine, there may be used C1-5 alkyl-substituted melamines such as methylolmelamine, methylmethylolmelamine and methylbutylolmelamine, urea, urethane, carbonic acid amides, dicyandiamide, guanidine, sulfurylamides, sulphonic acid amides, aliphatic amines, phenols and the derivatives thereof. As aldehydes, there may be used acetaldehyde, trimethylol acetaldehyde, acrolein, benzaldehyde, furfurol, glyoxal, phthalaldehyde, terephthalaldehyde, etc.

As the blowing agent, there may be used pentane, trichlorofluoromethane, trichlorotrifluoroethane, etc. However, use of so-called Fleons® such as trichlorofluoromethane is regulated from the point of view of environmental problems, thus not being preferred. On the other hand, pentane is preferred in that it easily provides a foam when used even in a small amount but, since it has a volatile flammability, it requires sufficient care in its handling. Further, as the catalyst, formic acid is commonly used and, as the emulsifier, anionic surfactants such as sodium sulfonate may be used.

The amount of the electromagnetic wave to be irradiated for accelerating the curing reaction of the reaction mixtures is preferably adjusted to be about 500 to about 1,000 kW, particularly about 600 to about 800 kW, in electric power consumption based on about 1 kg of an aqueous formaldehyde solution charged in the mold. In case when this electric power consumption is insufficient, there results an insufficient foaming, leading to production of a cured product with a high density. On the other hand, in case when the electric power consumption is excessive, the pressure upon foaming becomes seriously high, leading to serious exhaustion of the mold and even the possibility of explosion. Thus, electric power consumption outside the range is not preferred.

### Heat-Compression

According to the present invention, the melamine foam has been heat-compressed.

By “heat-compressed”, it is meant herein that the melamine foam has been subjected to two distinct operations: a heating step and a compression step. Those two steps may be conducted simultaneously or successively, depending on the desired end results and properties.

The compression may be achieved using any technique commonly known in the art. It can be achieved discontinuously on commercial single or multi-level plate presses or continuously on dual belt presses, roll stretching machines, calendars or multiple pairs of rolls arranged one after the other.

As for the heating step, it may be achieved via any techniques well known in the art, including but not limited to dry hot air or wet hot air convection, water-steam circulation, heating plates, or through radiation, e.g. with infrared radiation, high frequency radiation or with microwave radiations.

In one aspect of the invention, the melamine foam may be pre-heated before the compression step, using any of the techniques as mentioned above.

In a preferred execution of the present invention, the compression step is conducted simultaneously with the heating step of said melamine foam. In that specific case, the melamine foam is preferably compressed and heated simultaneously via pressure-contact with suitably heated plates.

In the context of the present invention, a melamine foam having a thickness before heat-compression of from about 2 to about 500 mm, preferably of from about 10 to about 300 mm, more preferably of from about 15 to about 200 mm, even more preferably of from about 20 to about 100 mm, most preferably of from about 25 to about 75 mm, is heat-compressed at a pressure of at least about 1 bar, preferably of from about 2 to about 200 bars, more preferably from about 2 to about 100 bars, even more preferably from about 2 to about 30 bars.

According to a preferred aspect of the present invention, the melamine foam is heat-compressed to a thickness of about 5:1 to about 1.2:1, preferably of about 3:1 to about 1.5:1, most preferably of about 2.2:1 to about 1.8:1. The previously-mentioned ratio, hereinafter referred to as the “compression factor”, represents the ratio of the thickness of the melamine foam before heat-compression to the thickness of the melamine foam after heat-compression.

The Applicant has surprisingly found that when the melamine foam has been heat-compressed at a temperature of from about 250° C. to about 300° C., preferably from about 260° C. to about 290° C., more preferably from about 265° C. to about 280° C., most preferably from about 270° C. to about 275° C., for about 1 minute to below about 3 minutes, preferably for about 1.5 minutes to about 2.5 minutes, most preferably for about 2 minutes to about 2.5 minutes, the corresponding cleaning implement 1 is capable of providing improved cleaning performance benefit on tough soils such as e.g. dried food stains, greasy stains, particulate stains, greasy soap scum or marker, when compared to the performance obtained with a similar but uncompressed melamine foam.

Without wishing to be bound by theory, it is believed that when submitted to the heat-compression as described herein, the network of interconnected filaments forming the open-celled structure of the melamine foam is modified such as to form more of the so-called “struts” in the external surface of the heat-compressed melamine foam. It is believed that the presence of these additional struts is responsible for the improved cleaning performance obtained by providing an enhanced scratching action against the dirt on the stained surface.

Advantageously, the cleaning implement 1 according to the present invention, remains completely safe to the treated surface, especially to more delicate hard-surfaces such as Plexiglas, enamel, glazed and non-glazed ceramic tiles, porcelain, linoleum, plastic, plastified wood or metal, varnished parquet, painted surfaces, wall paper.

The Applicant has no less surprisingly discovered that when the melamine foam has been heat-compressed at a temperature of from about 250° C. to about 300° C., preferably from about 260° C. to about 290° C., more preferably from about 270° C. to about 280° C., most preferably from about 273° C. to about 277° C., for about 1 minute to below about 3 minutes, preferably for about 1.5 minute to about 2.5 minute, most preferably for about 2 minutes to about 2.5 minutes, the corresponding cleaning implement 1 exhibits excellent compression stability upon storage, even under stressed storage conditions.

Indeed, when applying the heat-compression step as above-indicated, a quasi-permanent compression of the melamine foam may be obtained. By “quasi-permanent compression”, it is meant herein that substantially no or little decompression of the compressed melamine foam occurs in the thickness direction, even upon prolonged and wet storage conditions such as e.g. storage during about 120 hours at about 35° C. with about 80% of relative humidity.

The decompression of the melamine foam after heat-compression is hereinafter expressed as the “rebound factor” and is calculated according to the following formula:

Rebound factor=[(C₂−C₁)/C₁]×100

wherein C₁ represents the thickness of the melamine foam immediately after heat-compression and C₂ represents the thickness of the melamine foam after storing the heat-compressed melamine foam during about 120 hours at about 35° C. and with about 80% of relative humidity.

The Applicant has determined that when melamine foam has been heat-compressed as indicated above and stored during about 120 hours at about 35° C. and with about 80% of relative humidity, the rebound factor is kept below about 20%, preferably below about 10%, most preferably below about 5%.

Without being bound by theory, it is believed that the heat-compression as described herein provides enhanced chemical cross-linking at least on the surface of the melamine foam material which will consequently lead to obtain a more efficient retention of the compression. It is additionally possible that some mechanical entanglements which may occur within the melamine structure could help in retaining the applied deformation.

In a further aspect, it has been discovered that cleaning implement 1 according to the present invention exhibits improved mechanical performances when compared to the performances obtained with similar but uncompressed melamine foam. Better performances have indeed been observed when measuring mechanical parameters such as Tear resistance, Tensile strength, or resistance to Abrasion. The overall improvement in mechanical performances shown by the cleaning implement 1 of the present invention will lead to obtain implements 1 with increased durability and prolonged lifespan.

Without being bound by theory, it is thought that the overall improved mechanical performance obtained with the cleaning implement 1 according to the present invention, is due to the increased density of the melamine foam after being heat-compressed as indicated above.

Furthermore, the Applicant has discovered that the overall improved mechanical performance over uncompressed melamine foam, as indicated above, is preserved after ageing, and even after moist ageing. Indeed, after being exposed to an atmosphere of about 35° C. and about 80% of relative humidity for about 240 hours, the cleaning implement 1 according to the present invention still exhibits much improved mechanical performances in terms of Tear resistance and tensile strength than the uncompressed and non-aged melamine foam.

The excellent stability upon heat-compression achieved by the cleaning implement 1 of the present invention provides an efficient way to produce permanently molded parts from melamine foam. This property will greatly help in forming and shaping implements comprising melamine foam, having various three-dimensional shapes and sizes for aesthetic or functional purposes.

As a further advantage, it has been surprisingly found that the melamine foam, when heat-compressed according to the present invention, is not subject to yellowing, discoloration, decomposition or burning, in spite of the relatively high temperature at which the melamine foam is heat-compressed. This renders the cleaning implement 1 of the present invention fully suitable and acceptable for use as a large scale consumer product.

### Post-Processing the Melamine Foam

In order to obtain suitable cleaning implements 1 according to the present invention, the melamine foam may have to be modified or post-processed. Suitable modification may be, for example, a change in shape and/or size of the melamine foam. This modification can be done by any means known to those skilled in the art. Suitable means of modifying the shape and/or size of melamine foam may be selected from the group consisting of: cutting, breaking, tearing, and combinations thereof.

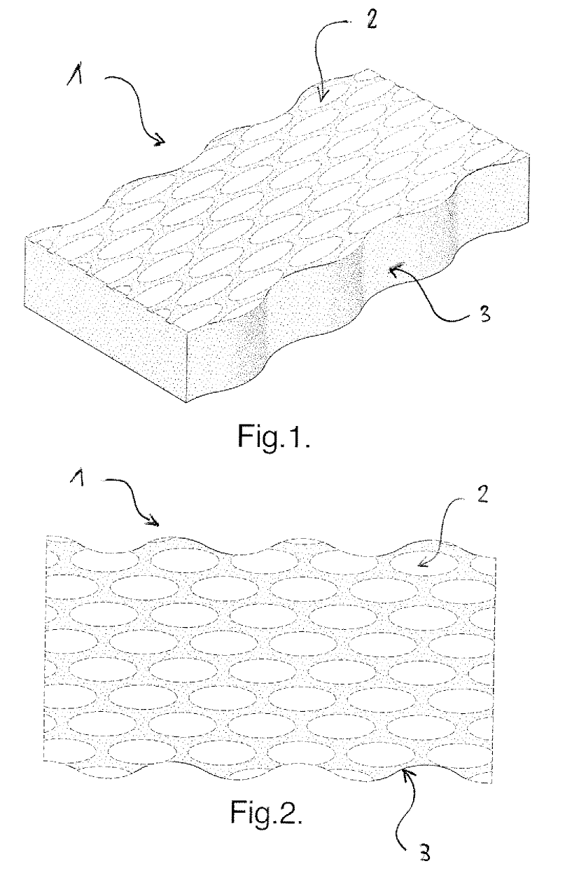

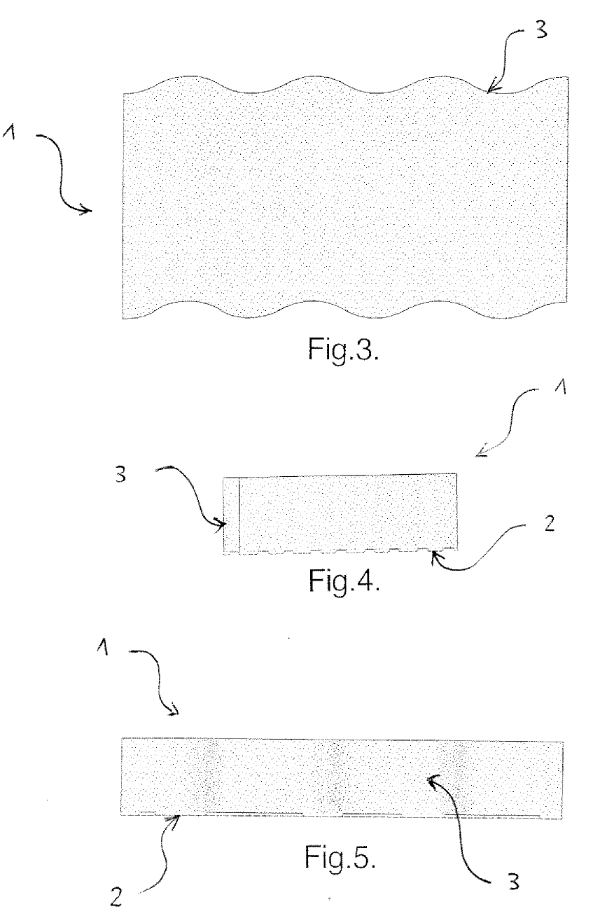

Accordingly, in a highly preferred execution the cleaning implement 1 has a rectangular shape wherein at least two parallel sides 3 are in a waved configuration (see FIG. 1). It is believed that such a preferred execution will lead to obtain better grip and manipulation of the cleaning implement 1 by the user while performing the cleaning action.

In another execution, the cleaning implement 1 of the present invention may be post-processed such as to associate a brand-name and/or a logo with said cleaning implement 1. Suitable modification and/or post-processing of the cleaning implement 1 may be selected from the group of printing on one or several sides of said cleaning implement, and/or embossing of one or several sides of said cleaning implement 1 using heat and/or pressure, and combinations thereof.

According to a preferred embodiment of the present invention, the cleaning implement 1 may be provided with an irregular portion in at least part of the surface thereof. It is indeed believed that such an irregular portion helps in obtaining enhanced mechanical cleaning action towards dirt present on stained hard-surfaces.

In a highly preferred execution of the present invention, the above-mentioned irregular portion is formed on at least part of the cleaning implement 1 surface simultaneously with the heat-compression of said melamine foam. This concomitant technical operation may practically be performed in a suitable mold provided with a corresponding irregular portion in at least part of the molding surface.

As a way of example, a highly preferred cleaning implement 1 according to the present invention and provided with a repetitive embossed pattern 2 onto one side of said cleaning implement 1, is represented in FIG. 1.

### Multi-Layer Cleaning Implement

In another embodiment, the cleaning implement 1 of the present invention may comprise a multi-layer structure including the above-described heat-compressed melamine foam. For example, the heat-compressed melamine foam may be laminated with a second layer selected from the group of polyurethane foams, polypropylene foams, polyethylene foams, cellulose foam sponges, naturally occurring sponges, open-cell polyester foams, cross-lined polyethylene foams, nonwoven web made from natural or polymeric fibers, and combinations thereof.

Preferably, said second layer has a water-absorbency of at least about 0.05 g, preferably at least about 0.10 g, more preferably at least about 0.20 g, even more preferably at least about 0.30 g, most preferably at least about 0.35 g of water per cm³ of said second layer. In a highly preferred embodiment, the heat-compressed melamine foam is laminated with a hydrophilic ester polyurethane foam as described e.g. in co-pending U.S. patent application No. 60/587,070, incorporated herein by reference. Suitable hydrophilic ester polyurethane foam is commercially available under the tradename Cellulex® from Foamex L.P. Hydrophilic ester polyurethane foams and their preparation is described in U.S. Pat. No. 6,756,416, incorporated herein by reference.

### Additional Material

The cleaning implement 1 may contain more than two layers, wherein said additional layers, if, any, may be of a material (additional material) other than said melamine foam and said second foam. The additional material may be suitable to provide beneficial features to the cleaning implement 1, such as abrasiveness or increased rigidity or increased grip.

In view thereof, said additional material may be a scouring material or a scouring pad, a rigid foam material, a handle made of thermoplastic material, wood, metal or combinations thereof, and the like.

### Process of Producing a Cleaning Implement 1

In another embodiment, the present invention encompasses a process of producing a cleaning implement 1 suitable for hard surface cleaning comprising heat-compressed melamine foam, wherein said process comprises the step of heat-compressing said melamine foam at about 250° C. to about 300° C., for about 1 minute to below about 3 minutes.

### Method of Obtaining Quasi-Permanent Compression of Melamine Foam

According to another aspect of the present invention, it is herewith provided a method of obtaining quasi-permanent compression of melamine foam comprising the step of heat-compressing said melamine foam at about 250° C. to about 300° C., for about 1 minute to below about 3 minutes.

### Use of a Cleaning Implement 1 Comprising Heat-Compressed Melamine Foam for Cleaning Hard Surfaces

In a further embodiment, the present invention is directed to the use of a cleaning implement 1 comprising heat-compressed melamine foam for cleaning hard surfaces, wherein said heat-compressed melamine foam has been heat-compressed at about 250° C. to about 300° C., for about 1 minute to below about 3 minutes.

Cleaning implements 1 according to the present invention are indeed capable of providing improved cleaning performance benefit on tough soils such as e.g. dried food stains, greasy stains, particulate stains or greasy soap scum, when compared to the performance obtained with a similar but uncompressed melamine foam.

### Method of Cleaning a Hard Surface

In still a further embodiment, the present invention encompasses a method of cleaning a hard surface by bringing a cleaning implement 1 comprising heat-compressed melamine foam into contact with said hard surface, wherein said heat-compressed melamine foam has been heat-compressed at about 250° C. to about 300° C., for about 1 minute to below about 3 minutes. By “cleaning” it is meant herein removing spots and/or stains from hard surfaces.

Suitable hard surfaces herein include but are not limited to tiles, walls, floors, sanitary fittings such as sinks, showers, shower curtains, wash basins, WCs, household appliances including, but not limited to, refrigerators, freezers, washing machines, automatic dryers, ovens, microwave ovens, dishwashers.

In the context of the present invention, suitable hard surfaces may also comprise more delicate hard-surfaces such as Plexiglas, enamel, glazed and non-glazed ceramic tiles, porcelain, linoleum, plastic, plastified wood or metal, varnished parquet, painted surfaces, wall paper.

The method of cleaning a hard surface according to the present invention may additionally include the step of wetting said cleaning implement with an appropriate solvent, preferably tap water, prior to bringing said cleaning implement into contact with said hard surface.

### Packaging Means

The cleaning implement 1 herein may be combined in an article of manufacture with a packaging means.

The packaging means herein may be any suitable means known to package cleaning implements 1. Indeed, particularly suitable packaging means herein are selected from the group consisting of: paper bags, plastic bags, cartons, carton boxes, flow wraps, plastic wraps, and paper wraps, and the like and combinations thereof.

The packaging means herein may be printed and/or modified. In particular, such printing and/or other modification may be used to associate a brand-name and/or logo of a hard surface cleaner with said cleaning implement 1.

### Test Methods

### Greasy Soap Scum and Neat Kitchen Dirt Cleaning Performance

In this test method enamel or ceramic white tiles (typically about 24 cm×4 cm) are covered with typical greasy soap scum or neat kitchen dirt soils commercially available (e.g. about 0.3 grams with a sprayer). The soiled tiles are then dried in an oven at a temperature of about 140° C. for about 20 minutes and then aged overnight at room temperature (around about 20° C. to about 25° C.). Then the soiled tiles are cleaned by rubbing the cleaning implement of the present invention towards the soiled parts of the tiles. The ability of the composition to remove stains is measured through the number of stroke cycles needed to perfectly clean the surface. The lower the number of stroke cycles, the higher the stain cleaning ability of the composition.

### Heat-Compression Stability Test

According to this method, melamine-formaldehyde resin foams raw material commercially available under the trade name Basotect® from BASF, are heat-compressed at the selected temperature and duration so as to obtain implements having a thickness after heat-compression of about 19 mm. The heat-compressed melamine foams so obtained are then stored in a climatic room for about 120 hours at about 35° C.±0.5° C. and with about 80% of relative humidity under controlled conditions of temperature and humidity. The thickness of the cleaning implements 1 is then measured after the about 120 hours of storage.

### EXAMPLES

A cleaning implement 1 was made using a melamine-formaldehyde resin foam raw material commercially available under the trade name Basotect® from BASF. The melamine foam was submitted to heat-compression at about 273° C. for about 2.5 minutes between two heated metal plates of a commercially available plate press. The compression factor is about 2.0:1. The resulting cleaning implement 1 provides excellent cleaning performance benefit, in particular on tough soils, and very good thermal compression stability upon storage, even under stressed storing conditions. Furthermore, the cleaning implement 1 shows improved mechanical performances and therefore improved durability when compared to non-thermally compressed melamine foams currently available on the market.

### Comparative Data

The following examples will further illustrate the present invention. The cleaning implements are made by heat-compressing melamine-formaldehyde resin foam raw material commercially available under the trade name Basotect® from BASF, at the specified temperatures and durations, and with a compression factor of about 2.0:1. Example cleaning implement 1 is meant to exemplify cleaning implements according to the present invention but is not necessarily used to limit or otherwise define the scope of the present invention. Example cleaning implements A, B and C are comparative examples. Cleaning implement C is a non-compressed melamine-formaldehyde resin foam raw material commercially available under the trade name Basotect® from BASF.

| Implements | 1 | A | B | C |
|---|---|---|---|---|
| Temperature of | 273 | 218 | 245 | N/A |
| compression (° C.) | | | | |
| Duration of heat- | 2.5 | 4 | 2.5 | N/A |
| compression (min) | | | | |

### Experiment 1

### Cleaning Performance

A comparative greasy soap scum and neat kitchen dirt removal performance study is conducted according to the test method as previously described. The study involves a cleaning implement 1 according to the present invention (Cleaning implement 1) and a comparative/reference cleaning implement (Cleaning implement C). For both cleaning implements, the number of stroke cycles needed to perfectly clean the surface is measured. Performances on greasy soap scum and neat kitchen dirt removal is evaluated for the exemplified cleaning implement (Implement 1) with respect to the reference cleaning implement (Cleaning implement C). The corresponding performances are expressed in terms of Cleaning Index, which was calculated according to the following formula:

Cleaning index(CI)=(NS₁/NS₂)×100

### Where

NS₁=number of stroke cycles needed for the reference cleaning implement C.

NS₂=number of stroke cycles needed for the tested cleaning implement 1.

Results are presented in the table below.

Cleaning Index

| | | Cleaning | Cleaning |
|---|---|---|---|
| Soil | Surface | implement 1 | implement C |
| Greasy soap scum | Enamel | 147 | 100 |
| Greasy soap scum | Ceramic | 163 | 100 |
| Neat kitchen dirt | Enamel | 140 | 100 |

The above results clearly show the improved cleaning performance obtained when using a cleaning implement 1 according to the present invention (Implement 1), over a comparative non-compressed implement (Implement C).

### Experiment 2

### Stability of the Heat-Compression Under Stressed Storing Conditions

Cleaning implements 1, A and B, are produced as indicated above and stored for about 120 hours at about 35° C. in a relative humidity of about 80%. The stability of the heat-compression under stressed conditions has been assessed using the test method as described herein above. The corresponding stabilities are expressed in terms of Rebound factor, which was calculated according to the formula as previously described. The lower the rebound factor, the lower decompression of the melamine foam after heat-compression is obtained, and therefore the better stability of the heat-compression under stressed conditions is achieved for the corresponding cleaning implements. Results are presented in the table below.

| | Cleaning | Cleaning | Cleaning |
|---|---|---|---|
| | implement 1 | implement A | implement B |
| Rebound factor | 8.9 | 34 | 21.3 |
| (%) | | | |

The above results clearly show the improved stability upon moist storage of a cleaning implement 1 according to the present invention (Cleaning implement 1), when compared to comparative cleaning implements not according to the invention (Cleaning implements A and B).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention.” To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for producing a cleaning implement suitable for hard surface cleaning comprising heat-compressing a melamine foam at about 250° C. to about 300° C., for about 1 minute to below about 3 minutes.

2. The process according to claim 1, wherein said melamine foam has been heat-compressed at about 260° C. to about 290° C.

3. The process according to claim 1, wherein said melamine foam has been heat-compressed at about 265° C. to about 280° C.

4. The process according to claim 1, wherein said melamine foam has been heat-compressed at about 270° C. to about 275° C.

5. The process according to claim 1, wherein said melamine foam has been heat-compressed for about 1.5 minutes to about 2.5 minutes.

6. The process according to claim 1, wherein said melamine foam has been heat-compressed for about 2 minutes to about 2.5 minutes.

7. The process according to claim 1, wherein said melamine foam has been heat-compressed to a thickness of about 5:1 to about 1.2:1.

8. The process according to claim 1, wherein said melamine foam has been heat-compressed to a thickness of about 3:1 to about 1.5:1.

9. The process according to claim 1, wherein said melamine foam has been compressed and heated simultaneously.

10. The process according to claim 9, wherein said heat-compressing has been operated by using forced hot air convection, water-steam circulation, heating plates, infrared radiation, high frequency radiation, microwave radiation, and combinations thereof.

11. The process according to claim 1, wherein said melamine foam has been preheated before being heat-compressed.

12. The process according to claim 1, wherein said melamine foam has been heat-compressed to provide an irregular portion in at least part of the surface of said melamine foam.

13. The process according to claim 1, wherein said melamine foam has a volume of from about 1 cm³ to about 10.000 cm³ after said heat-compressing step.

14. The process according to claim 1, wherein said melamine foam has been heat-compressed to a thickness of at least about 1 mm.

15. A process for producing a cleaning implement suitable for hard surface cleaning comprising:
a. heat-compressing a melamine foam at about 250° C. to about 300° C., for about 1 minute to below about 3 minutes, and
b. laminating said heat-compressed melamine foam with a second layer selected from the group consisting of polyurethane foams, polypropylene foams, polyethylene foams, cellulose foam sponges, naturally occurring sponges, open-cell polyester foams, cross-lined polyethylene foams, nonwoven web made from natural or polymeric fibers, and combinations thereof.

16. A cleaning implement according to claim 15, wherein said second layer has a water-absorbency of at least about 0.05 g of water per cm³ of said second layer

17. The process according to claim 15 wherein said second layer has a water-absorbency of at least about 0.20 g of water per cm³ of said second layer.

18. The process according to claim 15 wherein said second layer has a water-absorbency of at least about 0.35 g of water per cm³ of said second layer.

19. The process according to claim 15, wherein said melamine foam is a melamine-formaldehyde resin foam.

20. The process according to claim 15, wherein said second layer is a hydrophilic ester polyurethane foam.
